(19) United States
(12) Patent Application Publication
(10) Pub. No.: US 2016/0124225 A1
(43) Pub. Date: May 5, 2016

(54) HEAD-UP DISPLAY APPARATUS AND CONTROLLING METHOD THEREOF

(71) Applicant: Hyundai Motor Company, Seoul (KR)

(72) Inventor: Hee Chon Kwak, Seoul (KR)

(21) Appl. No.: 14/924,923

(22) Filed: Oct. 28, 2015

(30) Foreign Application Priority Data
Nov. 4, 2014 (KR) 10-2014-0152421

(51) Int. Cl. G02B 27/01; B60R 11/04; B60K 35/00; H04N 7/18

(52) U.S. Cl. CPC G02B 27/0101; H04N 7/183; B60R 11/04; B60K 35/00; G02B 2027/0138; B60K 2350/2013; B60K 2350/2052

(57) ABSTRACT

A head-up display apparatus and a control method are provided. The head-up display apparatus includes a windshield glass that has a transmittance adjustment region and a head-up display that displays an output image through a particular area of the windshield glass. The head-up display includes a display unit with which an imaging device configured to photograph a driver image is integrated and a signal output unit which is electrically connected to the transmittance adjustment region of the windshield glass and outputs a transmittance adjustment signal to the windshield glass in response to an operation of photograph an image by the imaging device.

### CROSS-REFERENCE TO RELATED APPLICATION

This application claims the benefit of priority to Korean Patent Application No. 10-2014-0152421, filed on Nov. 4, 2014 in the Korean Intellectual Property Office, the disclosure of which is incorporated herein in its entirety by reference.

### BACKGROUND

1. Field of the Invention

The present invention relates to a head-up display apparatus and a control method thereof, and more particularly, to a head-up display apparatus that integrates an imaging device, and a control method thereof.

2. Description of the Related Art

In general, a head-up display apparatus may include a separate imaging device (e.g., camera, video camera, or the like) for detecting a driver condition in front of a cluster (e.g., a dashboard). Particularly, the head-up display apparatus receives a driver image photographed by the imaging device to detect the driver. However, since the imaging device in the related art is installed in the dashboard, it may cover or block part of the dashboard. Thus, causing a restriction of the idiot light (e.g., indicator light) placement. Further, since the driver image is provided from the imaging device, a separate module for communicating with the imaging device is required.

### SUMMARY

The present invention provides a head-up display apparatus, in which an imaging device is integrated in a head-up display to directly recognize driver information using the imaging device, and adjust a setting based on the recognized driver information, and a control method thereof.

The present invention further provides a head-up display apparatus configured to obtain a reliable driver image by synchronizing a point of time of image capturing with a clock of a signal that controls a transmittance of a transmittance adjustment region of windshield glass to execute the transmittance when the image is captured, and a control method thereof.

In accordance with an aspect of the present invention, a head-up display apparatus may include: a windshield glass having a transmittance adjustment region; and a head-up display configured to display an output image through a certain area of the windshield glass, wherein the head-up display includes: a display unit having an integrated imaging device sensor configured to photograph a driver image; and a signal output unit electrically connected to the transmittance adjustment region of the windshield glass and is configured to output a transmittance adjustment signal to the windshield glass in response to an operation of the imaging device (e.g., in response to an image being captured). The signal output unit may be configured to synchronize a clock of the transmittance adjustment signal with a point of time of capturing an image.

A transmittance of the windshield glass may become about 0% by the transmittance adjustment signal. The imaging device (e.g., camera sensor) may be configured to obtain the driver image reflected from the transmittance adjustment region in which the transmittance is adjusted by the transmittance adjustment signal. Further, the display unit may include: a backlight module configured to output light that corresponds to the output image to a particular region of the windshield glass; and an infrared light-emitting diode (LED) configured to adjust ambient brightness when photographing or capturing the driver image. The infrared LED may be turned on when the imaging device operates within a predefined time interval. In addition, the head-up display may include: a reflection unit configured to transmit the driver image reflected on the transmittance adjustment region of the windshield glass to the imaging device of the display unit, and transmit the output image output from the display unit to a particular region of the windshield glass; and a motor configured to adjust an angle of the reflection unit.

In accordance with another aspect of the present invention, a method of controlling a head-up display apparatus may include: synchronizing a clock of a transmittance adjustment signal that executes a transmittance of a transmittance adjustment region of a windshield glass with a point of time of capturing an image by an imaging device (e.g., camera sensor) integrated in a display unit of a head-up display; outputting the transmittance adjustment signal to the transmittance adjustment region of the windshield glass; photographing using the imaging device when the transmittance of the transmittance adjustment region is adjusted by the transmittance adjustment signal; and obtaining a driver image reflected from the transmittance adjustment region in which the transmittance is adjusted.

### BRIEF DESCRIPTION OF THE DRAWINGS

The objects, features and advantages of the present invention will be more apparent from the following detailed description in conjunction with the accompanying drawings, in which:

FIG. 1 is a diagram illustrating a head-up display apparatus according to an exemplary embodiment of the present invention;

FIG. 2 is a diagram illustrating a display unit of a head-up display apparatus according to an exemplary embodiment of the present invention;

FIG. 3 is a block diagram illustrating a configuration of a head-up display apparatus according to an exemplary embodiment of the present invention;

FIGS. 4A-4C are exemplary diagrams for explaining an operation of a head-up display apparatus according to an exemplary embodiment of the present invention;

FIG. 5 is a flowchart illustrating an operation process of a control method of a head-up display apparatus according to a first embodiment of the present invention;

FIG. 6 is a flowchart illustrating an operation process of a control method of a head-up display apparatus according to a second embodiment of the present invention; and

FIG. 7 is a flowchart illustrating an operation process of a control method of a head-up display apparatus according to a third embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

Prior to a detailed description of the present invention, terms and words used in the specification and the claims shall not be interpreted as commonly-used dictionary meanings, but shall be interpreted as to be relevant to the technical scope of the invention based on the fact that the inventor may property define the concept of the terms to explain the invention in best ways. Therefore, the exemplary embodiments and the configurations depicted in the drawings are illustrative purposes only and do not represent all technical scopes of the embodiments, so it should be understood that various equivalents and modifications may exist at the time of filing this application. Some constituent elements shown in the drawings may be exaggerated, omitted or schematically drawn for the purpose of convenience or clarity. In addition, the size of elements does not utterly reflect an actual size. Accordingly, the present invention is not limited to a relative size and interval shown in the accompanying drawings.

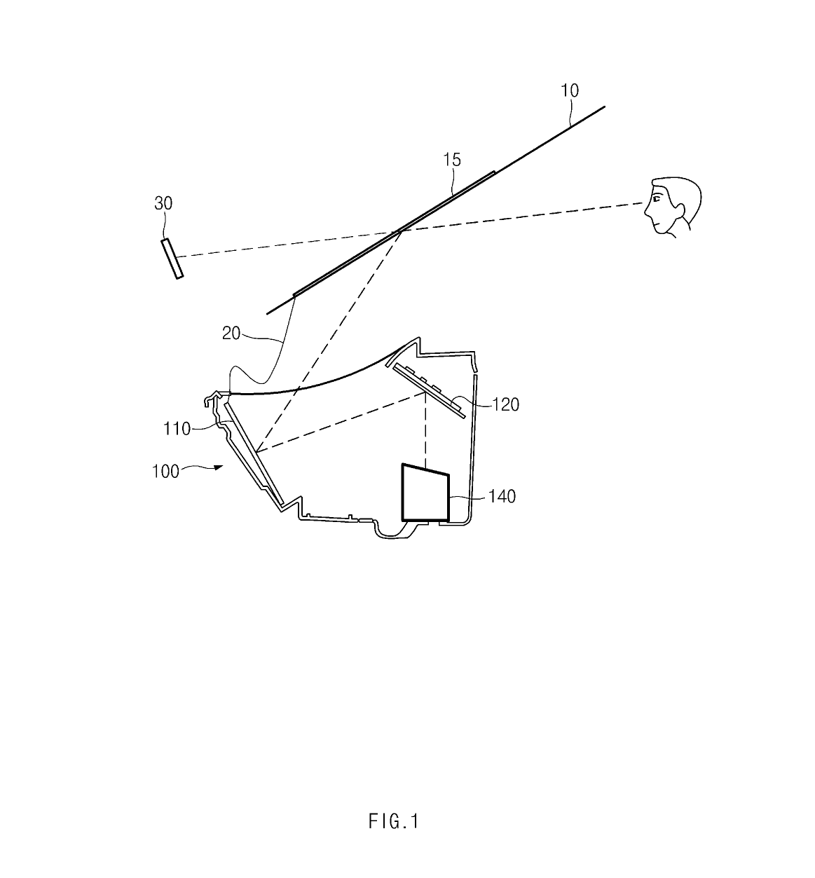

FIG. 1 is a diagram illustrating a head-up display apparatus according to an exemplary embodiment of the present invention. Referring to FIG. 1, the head-up display apparatus according to the present invention may include a windshield glass 10 and a head-up display 100. The various components of the apparatus may be executed by a controller having a processor and a memory.

The windshield glass 10 a display onto which an output image from the head-up display 100 may be projected. Meanwhile, the windshield glass 10 may reflect a driver image to transmit to the head-up display 100. In particular, the windshield glass 10 may also include a transmittance adjustment region 15. The transmittance adjustment region 15 may be implemented in a location where the driver image is reflected on the windshield glass 10. The transmittance adjustment region 15 may be electrically connected to the head-up display 100. As an example, the transmittance adjustment region 15 may be connected to the head-up display via an electrical wiring 20.

Further, the transmittance of the transmittance adjustment region 15 may be adjusted by a transmittance adjustment signal received via the electrical wiring 20. For example, the transmittance of transmittance adjustment region 15 may be about 100%. Meanwhile, the transmittance of transmittance adjustment region 15 may be adjusted to about 0% when the transmittance adjustment signal is received. In particular, the reflectance of the windshield glass 10 may be increased such that an imaging device may obtain a reliable driver image.

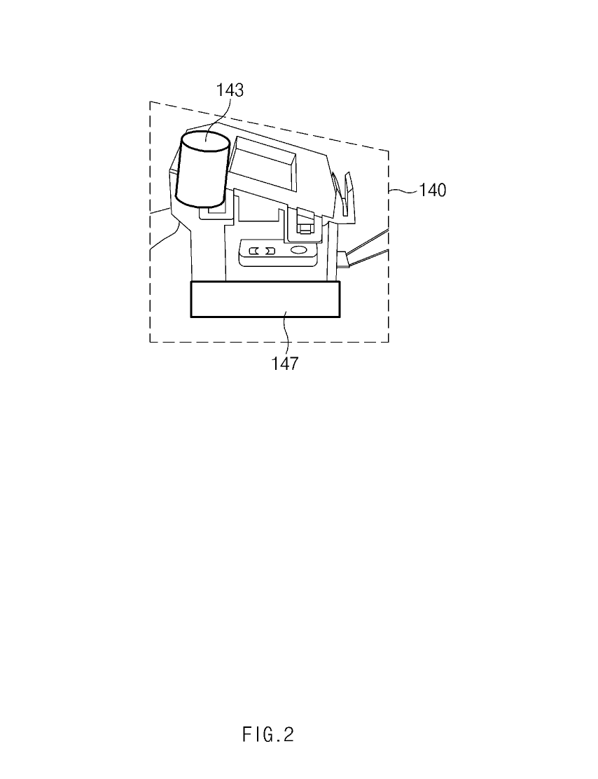

The head-up display 100 may be implemented with a structure in which the imaging device (e.g., camera sensor) is integrated within a display unit 140. Since an imaging device for capturing an image of a driver need not to be provided separately to a dashboard or the like, the covering or blocking of dashboard or the like may be prevented. The display unit 140 may further include a display module configured to adjust the output image displayed on the windshield glass 10 and a backlight module configured to output light that corresponds to the output image by the control of the display module. In addition, the display unit 140 may further include an infrared Light Emitted Diode (LED) 147 configured to adjust the ambient illumination when capturing a driver image using an imaging device 143. Such a display unit 140 may be implemented as shown in FIG. 2.

The head-up display 100 may be configured to output a transmittance adjustment signal to the transmittance adjustment region 15 of the windshield glass 10 in response to the operation of the imaging device. The transmittance adjustment signal may synchronize a clock with a point of time of photographing by the imaging device. Further, the head-up display 100 may include a first reflection unit 110 and a second reflection unit 120. In particular, the first reflection unit 110 may be configured to transmit the driver image reflected in the windshield glass 10 to the second reflection unit 120, and the second reflection unit 120 may be configured to transmit the driver image transmitted from the first reflection unit 110 to the imaging device of the display unit 140. Therefore, the imaging device may be configured to obtain the driver image transmitted from the second reflection unit 120.

In addition, the second reflection unit 120 may be configured to transmit the output image output from the backlight module of the display unit 140 to the first reflection unit 110, and the first reflection unit 110 may be configured to transmit the output image transmitted from the second reflection unit 120 to a particular area of the windshield glass 10. The output image may be displayed through the particular area of the windshield glass 10. Particularly, the first reflection unit 110 may be implemented as an aspheric mirror and the second reflection unit 120 may be implemented as a plane minor. However, these implementations are mere examples and other various implementations may be applied.

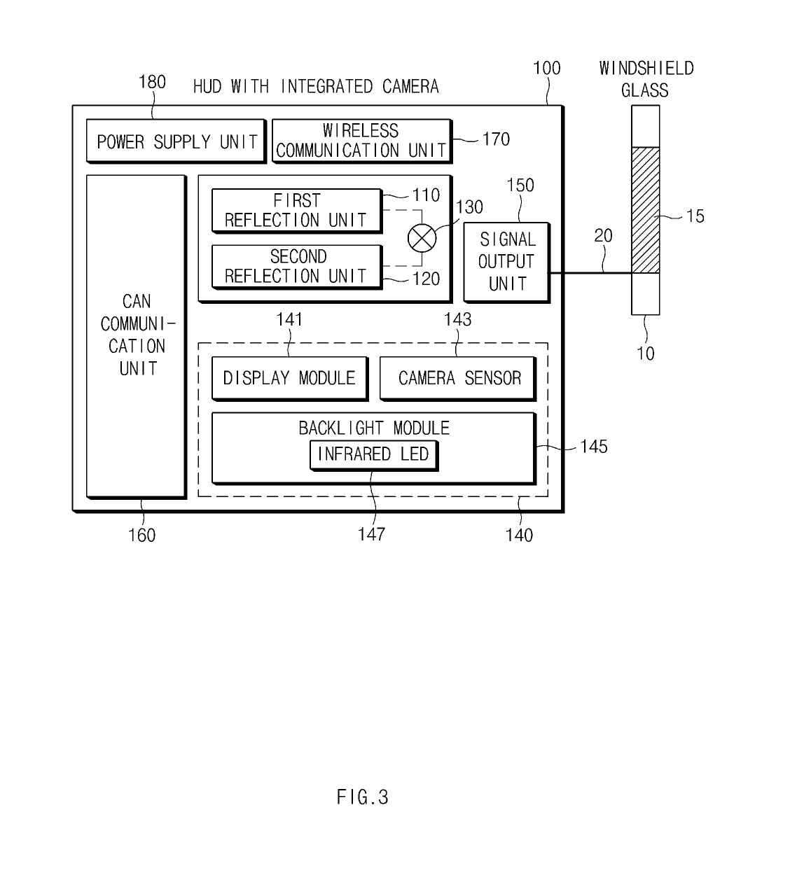

Thus, an operation of the head-up display apparatus is described in detail with reference to an exemplary embodiment of FIG. 3. FIG. 3 is a block diagram illustrating a configuration of a head-up display apparatus according to an exemplary embodiment of the present invention. Referring to FIG. 3, the head-up display apparatus may include a windshield glass 10 and a head-up display 100. The output image output by the head-up display 100 may be projected to a particular area of the windshield glass 10 to allow the driver to detect or view the output image on the windshield glass 10 in front of a vehicle. Further, the windshield glass 10 may reflect the driver image, and transmit the reflected driver image to the head-up display 100.

As described above, the windshield glass 10 may include the transmittance adjustment region 15, in which transmittance may be adjusted by an electrical signal, in a particular area which reflects the driver image. The transmittance adjustment region 15 may be connected to the head-up display 100 via the electrical wiring 20. When the transmittance adjustment signal is received via the electrical wiring 20, the transmittance may be adjusted accordingly. In particular, the transmittance adjustment region 15 may be implemented as a polarization structure, and the transmittance may be varied by the transmittance adjustment signal.

For example, after the transmittance adjustment region 15 may maintain the transmittance to be about 100%, when the transmittance adjustment signal is received from the head-up display 100, the instantaneous transmittance may become about 0%. When the transmittance is adjusted by the transmittance adjustment signal may be a time between before a certain time and after a certain time based on a point of time of photographing the driver image by the imaging device 143 of the head-up display 100. In other words, it can be understood that a point of time of photographing an image and a point of time of transmittance adjustment may be synchronized and operated.

Meanwhile, the head-up display 100 may include a first reflection unit 110, a second reflection unit 120, a motor 130, a display unit 140, a signal output unit 150, a controller area network (CAN) communication unit 160, a wireless communication unit 170, and a power supply unit 180. The various components and units of the head-up display 100 may be executed by a controller.

First, the first reflection unit 110 may be configured to transmit the driver image reflected on the windshield glass 10 to the second reflection unit 120. In addition, the first reflection unit 110 may be configured to transmit the output image transmitted from the second reflection unit 120 to a particular area of the windshield glass 10. The first reflection unit 110 may be implemented as an aspheric minor. The second reflection unit 120 may be configured to transmit the driver image transmitted from the first reflection unit 110 to the imaging device 143 of the display unit 140. In addition, the second reflection unit 120 may be configured to transmit the output image output from the backlight module of the display unit 140 to the first reflection unit 110. Particularly, the second reflection unit 120 may be implemented as a plane mirror.

The angles of the first reflection unit 110 and the second reflection unit 120 may be adjusted by the motor 130. For example, when it is impossible to recognize a driver from the driver image transmitted to the imaging device 143 through the first reflection unit 110 and the second reflection unit 120, the motor 130 may be configured to adjust the angles of the first reflection unit 110 and the second reflection unit 120 so that the driver image having a higher recognizability (e.g., detection) may be transmitted to the imaging device 143.

The display unit 140 may include the display module 141, the imaging device (e.g., camera sensor) 143, the backlight module 145 and the infrared LED 147. In particular, the display module 141 may be configured to adjust the output image displayed on the windshield glass 10. The display module 141 may then be configured to recognize or detect the driver from the image obtained by the imaging device 143, and set a display environment that corresponds to the driver. For example, the display module 141 may be configured to set the size, the location, the brightness, or the like of information displayed on the windshield glass 10, and an area that displays the output image on the windshield glass 10 in response to the recognized driver. In addition, the display module 141 may be configured to set the display environment based on the condition input from the driver.

In addition, the display module 141 may be configured to operate the imaging device 143, the backlight module 145 and the infrared LED 147. The display unit 140 may be further provided with a separate control module (e.g., a controller) for operating the imaging device 143, the backlight module 145 and the infrared LED 147, in addition to the display module 141.

The imaging device 143 may be implemented in a form of being integrated in the display module 141. Therefore, it is not necessary to additionally assign a separate space for mounting the imaging device 143. In particular, the imaging device 143 may be configured to receive the driver image reflected to the windshield glass 10 through the first reflection unit 110 and the second reflection unit 120 to obtain the driver image. It may be assumed that the driver image transmitted via the first reflection unit 110 and the second reflection unit 120 is an image reflected from the transmittance adjustment region 15 of the windshield glass (10.

Thus, the imaging device 143 may be configured to start photographing by synchronizing a clock of the transmittance adjustment signal of the signal output unit 150 with a point of time of photographing an image. In particular, the imaging device 143 may be configured to obtain the driver image reflected when the transmittance of the transmittance adjustment region 15 is decreased. At this time, the imaging device 143 may be configured to provide the driver image to the display module 141 to recognize the driver from the driver image.

The backlight module 145 may be configured to output a light that corresponds to the output image under the control of the display module 141. In particular, the output light may be projected into a particular area of the windshield glass 10 through the second reflection unit 120, and the first reflection unit 110. The backlight module 145 may be a light source for image projection, and may be implemented by LED.

The infrared LED 147 may be configured to adjust the brightness of the driver's surroundings when the driver image is photographed by the imaging device 143. Particularly, the infrared LED 147 may be turned on when a certain condition is satisfied within a predefined time interval. For example, the infrared LED 147 may not operate during the daytime when surrounding environment is bright, and may be turned on when the imaging device 143 operates during the night. Additionally, the infrared LED 147 may be integrally formed in the backlight module 145. In other words, the infrared LED 147 may be arranged with the LED for image projection of the backlight module 145. The infrared LED 147 may be implemented separately from the backlight module 145 based on an exemplary embodiment of the present invention.

The signal output unit 150 may be electrically connected to the transmittance adjustment region 15 of the windshield glass 10. For example, the signal output unit 150 may be connected to the transmittance adjustment region 15 via the electrical wiring 20, and may be electrically connected by other connecting means.

Furthermore, the signal output unit 150 may be configured to output the transmittance adjustment signal to the transmittance adjustment region 15. In particular, the signal output unit 150 may be configured to output the transmittance adjustment signal by adjusting the clock of the transmittance adjustment signal. When the imaging device 143 operates, the signal output unit 150 may be configured to output the transmittance adjustment signal to the transmittance adjustment region 15 by synchronizing a clock of the transmittance adjustment signal with a point of time of photographing an image. The width of the clock (e.g., the time range) of the transmittance adjustment signal may be varied based on the performance of the imaging device 143 or the time when the driver image reaches the imaging device 143 after being reflected on the windshield glass 10, and may be set to the time interval which does not disturb the driving.

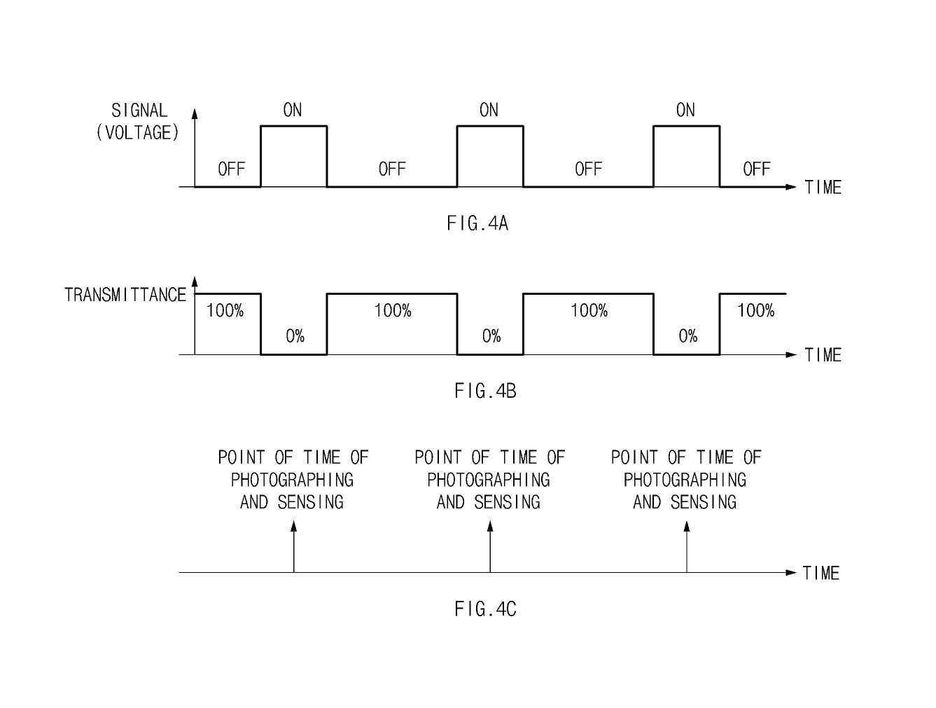

Particularly, since the imaging device 143 should photograph the driver image when the transmittance of the transmittance adjustment control region 15 is adjusted by the transmittance adjustment signal, the signal output unit 150 may be configured to output the transmittance adjustment signal before the imaging device 143 starts photographing. Thus, the time of transmittance adjustment signal output by the signal output unit 150, the transmittance of the transmittance adjustment control region 15 of the windshield glass 10, and the point of time of photographing the image may be expressed as shown in FIGS. 4A-4C.

Referring to FIG. 4A, shows a time of the transmittance adjustment signal output by the signal output unit 150, FIG. 4B shows a transmittance variation of the transmittance adjustment region 15 of the windshield glass 10, and FIG. 4C shows a point of time of photographing by the imaging device 143.

As shown in FIG. 4B, the transmittance of transmittance adjustment region 15 may be maintained at about 100%. At this time, when the clock (e.g., the time) of the transmittance adjustment signal becomes a high level, i.e., an ON state as shown in FIG. 4A, the transmittance of transmittance adjustment region 15 may be adjusted to about 100% while the clock of the transmittance adjustment signal maintains the ON state. Further, when the clock of the transmittance adjustment signal is switched from the ON state to the OFF state, the transmittance of the transmittance adjustment region 15 may be still be maintained at about 100%.

Meanwhile, the point of time of photographing and image sensing by the imaging device 143 may be synchronized with the clock of the transmittance adjustment signal. In particular, the synchronization may be achieved at the point of time before the clock is turned off, after the clock is turned on since the driver image reflected on the transmittance adjustment region 15 when transmittance is decreased may be obtained when the photographing is initiated after the clock is turned on, as it takes time for the driver image to reach the imaging device 143 via the first reflection unit 110 and the second reflection unit 120 after being reflected to the windshield glass 10.

A controller area network (CAN) communication unit 160 may be connected with the electronic unit and/or controllers disposed within the vehicle to perform communication and receive particular information. For example, the CAN communication unit 160 may be configured to receive user setting information of the head-up display 100, display information of the head-up display, and the like from a dashboard, a navigation device, an audio-video-navigation (AVN) system, or the like of the vehicle. In addition, the CAN communication unit 160 may be configured to receive daytime or nighttime information, front luminance information, or the like from the controller including an auto-light sensor. The CAN communication unit 160 may further be configured to receive boarding information of driver from a sensor disposed within the vehicle, or a seat controller, or the like.

The information received by the CAN communication unit 160 may be transmitted to the display unit 140, and may be used to set the head-up display environment that corresponds to the user in the display module 141, and may be used to operate the infrared an LED 147 when the imaging device 143 operates. The exemplary embodiment of the present invention has been described only for the CAN communication, however, it is obvious that various types of vehicle network communication method such as a Local Interconnect Network (LIN) communication, a Flex-Ray communication, or the like may be applied.

The wireless communication unit 170 may be configured to transmit and receive a signal with an external communication device via a wire/wireless communication method. For example, the wireless communication unit 170 may be configured to receive head-up display setting information via communication with an external device that stores information regarding user's head-up display setting, and may be configured to transmit the user's head-up display setting information set in the head-up display 100 to the external device.

Particularly, the wireless communication unit 170 may include a module for wireless internet access or a module for short range communication. The wireless internet technology may include Wireless LAN (WLAN), Wireless Broadband (Wibro), Wi-Fi, World Interoperability for Microwave Access (Wimax), High Speed Downlink Packet Access (HSDPA), and the like. In addition, the short range communication technology may include Bluetooth, ZigBee, Ultra Wideband (UWB), Radio Frequency Identification (RFID), Infrared Data Association (IrDA), and the like. Further, the wired communication technology may include a Universal Serial Bus (USB) communication), and the like. The power supply unit 180 may be connected to the power supply apparatus of the vehicle and may be supplied with a power required for driving the head-up display 100.

Although not shown in FIG. 3, the head-up display apparatus may further include an input unit (not shown) configured to receive particular information and/or instruction from the driver. The input unit may correspond to a key button implemented in the exterior of the head-up display 100, and may correspond to a key button on instrument panel associated with the head-up display apparatus. Further, the input unit may be an input device in the form of a mouse, a joystick, a jog shuttle, a stylus pen, and the like. The head-up display apparatus may also include an output unit (not shown) configured to output a voice, an alarm, a warning, or the like based on an operation of the head-up display 100. The head-up display apparatus may further include a storage unit (not shown) configured to store data and program necessary to operate the head-up display apparatus.

In particular, the storage unit may include at least one of storage media among a flash memory type, a hard disk type, a multimedia card micro type, a card type memory (e.g., SD or XD memory, or the like), a magnetic memory, a magnetic disk, an optical disk, a random access memory (RAM), a static random access memory (SRAM), a read-only memory (ROM), a programmable read-only memory (PROM), and an electrically erasable programmable read-only memory (EEPROM).

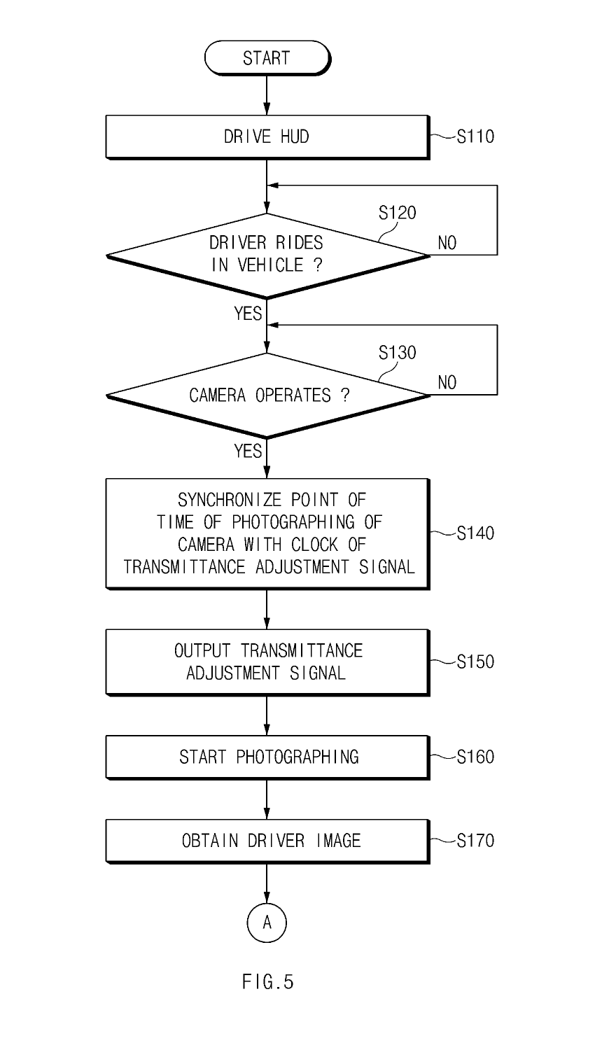

The operation process of a head-up display apparatus according to the present invention configured as mentioned above is described in more detail hereinbelow. FIG. 5 is a flowchart illustrating an operation process of a control method of a head-up display apparatus according to a first embodiment of the present invention. As shown in FIG. 5, when the head-up display (HUD) may be operated (S110), the head-up display apparatus may be configured to determine whether the driver is within the vehicle. When the driver is determined or detected to be within the vehicle (S120), and, when the imaging device is operating (S130), a point of time of photographing an image by the imaging device and a clock of the transmittance adjustment signal for adjusting transmittance for the transmittance adjustment region of windshield may be synchronized (S140).

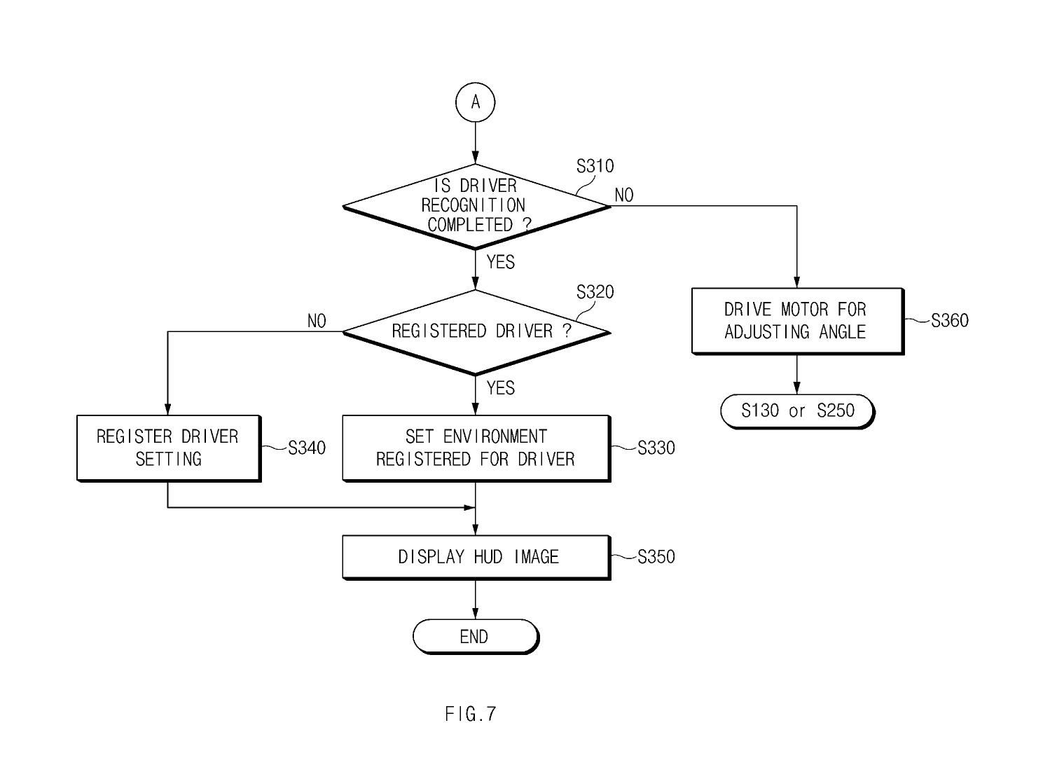

The transmittance adjustment signal having a clock synchronized with the point of time of photographing an image may be output to the transmittance adjustment region of the windshield glass (S150). The imaging device may then be configured to begin photographing after the transmittance adjustment signal is output to the transmittance adjustment region at step ‘S150’ (S160). In particular, the imaging device may be configured to obtain the driver image reflected to the transmittance adjustment region of the windshield glass when the transmittance of the transmittance adjustment region is reduced to about 0% by the transmittance adjustment signal (S170). Then, the head-up display apparatus may enter the process after ‘A’, and perform the operations of FIG. 7.

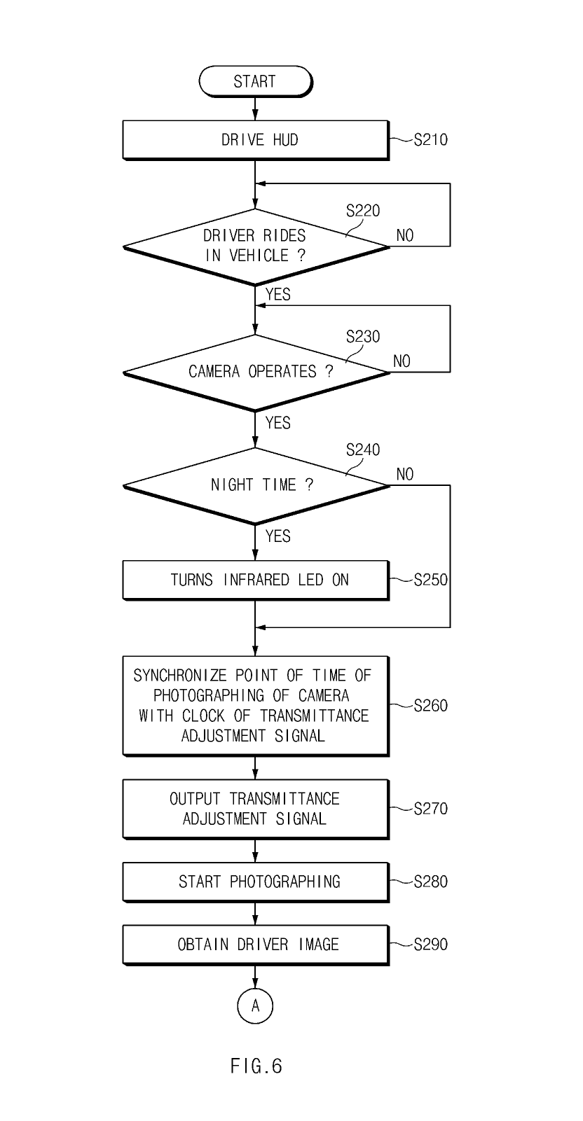

Meanwhile, FIG. 6 is a flowchart illustrating an operation process of a control method of a head-up display apparatus according to a second exemplary embodiment of the present invention. As shown in FIG. 6, when the head-up display (HUD) may be operated (S210), the head-up display apparatus may be configured to determine or detect whether the driver is within the vehicle. When the driver is within the vehicle (S220), and, when the imaging device is operating (S230), whether the current time is night time (e.g., low lighting conditions) may be determined (S240). In response to determining that the current time is night time, the head-up display apparatus may be configured to turn on an infrared LED on (S250). The infrared LED allows the driver image to be captured when the brightness of the driver's surrounding is adjusted.

Then, the head-up display apparatus may be configured to synchronize the point of time of photographing an image with the clock of the transmittance adjustment signal for adjusting the transmittance for the transmittance adjustment region of the windshield glass (S260). The transmittance adjustment signal having a clock synchronized with the point of time of photographing an image may be output to the transmittance adjustment region of the windshield glass (S270). The imaging device may then be configured to start photographing after the transmittance adjustment signal is output to the transmittance adjustment region at step ‘S270’ (S280). Particularly, the imaging device may be configured to obtain the driver image reflected to the transmittance adjustment region of the windshield glass when the transmittance of the transmittance adjustment region is reduced to about 0% by the transmittance adjustment signal (S290).

Further, the head-up display apparatus may enter the process after ‘A’, and perform the operations of FIG. 7. FIG. 7 is a flowchart illustrating an operation process of a control method of a head-up display apparatus according to a third exemplary embodiment of the present invention. As shown in FIG. 7, the head-up display apparatus may be configured to detect the driver from the driver image obtained from step ‘S170’ of FIG. 5 or step ‘S290’ of FIG. 6. At this time, when the driver recognition is not completed from the driver image (S310), the head-up display apparatus may be configured to operate the motor to adjust the angles of the first reflection unit and the second reflection unit (S360), and may repeat step ‘S130’ of FIG. 5 or step ‘S250’ of FIG. 6.

When the driver is detected at step ‘S310’, the head-up display apparatus may be configured to determine whether the recognized driver is a registered driver. When the driver is a registered driver (S320), and an environment registered for a corresponding driver may be set (S330). When the recognized driver is not a registered driver (S320), the head-up display apparatus may be configured to register driver setting based on driver's operation, setting information of corresponding driver received from the vehicle controller, and setting information of driver received from the communication-linked external device, and the like (S340). Then, the head-up display apparatus may be configured to output an image according to an environment registered for a corresponding driver and display through the windshield (S350).

The above mentioned process may be directly implemented by a hardware, a software module, or a combination of the two executed by a processor. The software module may reside in a storage medium, that is, in a memory and/or a storage such as a RAM memory, a flash memory, a ROM memory, an EPROM memory, an EEPROM memory, a register, a hard disk, a removable disk, and CD-ROM. The exemplary storage medium may be coupled to a processor, and the processor may read information from the storage medium and write information to the storage medium. Alternatively, the storage medium may be integrated in the processor. The processor and the storage medium may reside in an application specific integrated circuit (ASIC). The ASIC may reside in a user terminal. Alternatively, the processor and the storage medium may reside in the user terminal as an individual component.

The present invention may integrate an imaging device into a head-up display to directly detect driver information using the imaging device, and may obtain a driver image having a higher reliability by synchronizing a point of time of photographing by an imaging device integrated in the head-up display with a clock of a signal that adjusts a transmittance of transmittance adjustment region of windshield glass to adjust the transmittance instantaneously when capturing the driver image.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A head-up display apparatus, comprising:
a windshield glass having a transmittance adjustment region; and
a head-up display configured to display an output image through a particular area of the windshield glass,
wherein the head-up display comprises:
a display unit with which an imaging device sensor configured to photograph a driver image is integrated; and
a signal output unit electrically connected to the transmittance adjustment region of the windshield glass and configured to output a transmittance adjustment signal to the windshield glass in response to an operation of photographing an image by the imaging device.

2. The head-up display apparatus of claim 1, wherein the signal output unit is configured to synchronize a clock of the transmittance adjustment signal with a point of time of photographing an image by the imaging device.

3. The head-up display apparatus of claim 1, wherein a transmittance of the windshield glass becomes about 0% by the transmittance adjustment signal.

4. The head-up display apparatus of claim 3, wherein the imaging device is configured to obtain the driver image reflected from the transmittance adjustment region in which the transmittance is adjusted by the transmittance adjustment signal.

5. The head-up display apparatus of claim 1, wherein the display unit includes:
a backlight module configured to output light that corresponds to the output image to the particular region of the windshield glass; and
an infrared light-emitting diode (LED) configured to adjust ambient brightness when photographing the driver image by the imaging device.

6. The head-up display apparatus of claim 5, wherein the infrared LED is turned on when the imaging device operates within a predefined time interval.

7. The head-up display apparatus of claim 1, wherein the head-up display includes:
a reflection unit configured to transmit the driver image reflected on the transmittance adjustment region of the windshield glass to the imaging device of the display unit, and transmit the output image output from the display unit to the particular region of the windshield glass; and
a motor configured to adjust an angle of the reflection unit.

8. A method of controlling a head-up display apparatus, comprising:
synchronizing, by a controller, a clock of a transmittance adjustment signal that adjusts a transmittance of a transmittance adjustment region of a windshield glass with a point of time of photographing an image by an imaging device sensor integrated in a display unit of a head-up display;
outputting, by the controller, the transmittance adjustment signal to the transmittance adjustment region of the windshield glass;
photographing, by the controller, the image using the imaging device when the transmittance of the transmittance adjustment region is adjusted by the transmittance adjustment signal; and
obtaining, by the controller, a driver image reflected from the transmittance adjustment region in which the transmittance is adjusted.

9. The method of claim 8, wherein the transmittance of transmittance adjustment region of the windshield glass becomes about 0% by the transmittance adjustment signal.

10. The method of claim 8, further comprising:
adjusting, by the controller, ambient brightness when photographing the driver image by using an infrared light-emitting diode (LED) disposed within the display unit.

11. The method of claim 10, wherein adjusting ambient brightness includes:
adjusting, by the controller, ambient brightness when the imaging device operates within a predefined time interval.

12. The method of claim 8, further comprising:
adjusting, by the controller, an angle of reflection unit for transmitting the driver image reflected to the transmittance adjustment region of the windshield glass to the imaging device, a driver recognition fails from the driver image obtained while capturing the driver image.

13. A non-transitory computer readable medium containing program instructions executed by a controller, the computer readable medium comprising:
program instructions that synchronize a clock of a transmittance adjustment signal that adjusts a transmittance of a transmittance adjustment region of a windshield glass with a point of time of photographing an image by an imaging device sensor integrated in a display unit of a head-up display;
program instructions that output the transmittance adjustment signal to the transmittance adjustment region of the windshield glass;
program instructions that photograph the image using the imaging device when the transmittance of the transmittance adjustment region is adjusted by the transmittance adjustment signal; and
program instructions that obtain a driver image reflected from the transmittance adjustment region in which the transmittance is adjusted.

14. The non-transitory computer readable medium of claim 13, wherein the transmittance of transmittance adjustment region of the windshield glass becomes about 0% by the transmittance adjustment signal.

15. The non-transitory computer readable medium of claim 13, further comprising:
program instructions that adjust ambient brightness when photographing the driver image by using an infrared light-emitting diode (LED) disposed within the display unit.

16. The non-transitory computer readable medium of claim 15, wherein the program instructions that adjust ambient brightness include:
program instructions that adjust ambient brightness when the imaging device operates within a predefined time interval.

17. The non-transitory computer readable medium of claim 13, further comprising:
program instructions that adjust an angle of reflection unit for transmitting the driver image reflected to the transmittance adjustment region of the windshield glass to the imaging device, a driver recognition fails from the driver image obtained while capturing the driver image.
